(19) United States
(12) Patent Application Publication
(10) Pub. No.: US 2026/0186524 A1
(43) Pub. Date: Jul. 2, 2026

(54) ELECTRONIC DEVICE THAT CORRECTS DRIFT OF CLOCK SIGNAL IN CHIP DUE TO TIME

(71) Applicant: Nuvoton Technology Corporation, Hsinchu Science Park (TW)

(72) Inventor: Chih-Ming CHEN, Jhuangwei Township (TW)

(21) Appl. No.: 19/347,094

(22) Filed: Oct. 1, 2025

(30) Foreign Application Priority Data
Dec. 27, 2024 (TW) 113151053

(51) Int. Cl. G06F 1/08; G06F 1/12; G06F 1/14

(52) U.S. Cl. CPC G06F 1/08; G06F 1/12; G06F 1/14

(57) ABSTRACT

An electronic device includes a logic controller, a time digital converter, and a clock adjustment circuit. The logic controller receives a clock signal and generates a first signal and a second signal according to the clock signal. The first signal leads the second signal by a first time difference. The time digital converter includes a plurality of delay circuits, receives the first signal and the second signal, and enables the second signal to catch up with the first signal in a second time difference through the delay circuits. The clock adjustment circuit adjusts the frequency of the clock signal according to the sum of the first time difference and the second time difference respectively calculated in the previous and subsequent periods of the clock signal.

### CROSS REFERENCE TO RELATED APPLICATIONS

This application claims the benefit of Taiwan application No. 113151053, filed on Dec. 27, 2024, the entirety of which is incorporated by reference herein..

### BACKGROUND OF THE INVENTION

### Field of the Invention

The present invention relates to an electronic device, and, in particular, it relates to an electronic device for correcting the time-dependent drift of clock signals in a chip.

### Description of the Related Art

The most important source of chip operation is the clock signal generated by the internal resistor-capacitor (RC) crystal oscillator, and its accuracy may be affected by different degrees of frequency drift due to different manufacturing processes. Therefore, each chip will be verified for its RC clock output before leaving the factory, and the most appropriate adjustment value for each chip will be adjusted and set to ensure that the output frequency of the RC crystal oscillator is within working specifications required by the chip.

However, as the chip ages, the weakening of the RC crystal oscillator component will become apparent, directly affecting the accuracy of the component's output frequency. Therefore, how to detect the weakening of RC crystal oscillator components and automatically adjust the adjustment value of the RC crystal oscillator components to restore the chip to the original clock signal accuracy has become an important issue.

### BRIEF SUMMARY OF THE INVENTION

An embodiment of the present invention provides an electronic device. The electronic device includes a logic controller, a time digital converter, and a clock adjustment circuit. The logic controller receives a clock signal and generates a first signal and a second signal according to the clock signal. The first signal leads the second signal by a first time difference. The time digital converter includes a plurality of delay circuits, receives the first signal and the second signal, and enables the second signal to catch up with the first signal in a second time difference through the delay circuits. The clock adjustment circuit adjusts the frequency of the clock signal according to the sum of the first time difference and the second time difference respectively calculated in the previous and subsequent periods of the clock signal.

According to the electronic device described above, the delay circuits include a first ring delay circuit and a second ring delay circuit. The first ring delay circuit receives the first signal. When the first signal travels one lap in the first ring delay circuit, the first ring delay circuit outputs a first indication signal accordingly. The second ring delay circuit receives the second signal. When the second signal travels one lap in the second ring delay circuit, the second ring delay circuit outputs a second indication signal accordingly.

According to the electronic device described above, the first ring delay circuit includes a first NAND gate and a plurality of first inverters. The first NAND gate a first input end, a second input end, and an output end. The second input end receives the first signal. Each first inverter is connected in series. The first inverter among the first inverters is electrically connected to the output end of the first NAND gate, and the last inverter among the first inverters is electrically connected to the first input end of the first NAND gate. The last inverter among the first inverters outputs the first indication signal.

According to the electronic device described above, the second ring delay circuit includes a second NAND gate and a plurality of second inverters. The second NAND gate includes a first input end, a second input end, and an output end. The second input end receives the second signal. Each second inverter is connected in series. The first inverter among the second inverters is electrically connected to the output end of the second NAND gate, and the last inverter among the second inverters is electrically connected to the first input end of the second NAND gate. The last inverter among the second inverters outputs the second indication signal. The number of second inverters is equal to the number of first inverters.

According to the electronic device described above, the time digital converter includes a plurality of trigger circuits. One of the trigger circuits is connected between the output end of the first NAND gate and the output end of the second NAND gate. Each of the rest of trigger circuits is connected between each of the first inverters and each of the second inverters. When the second signal catches up with the first signal, said trigger circuit outputs a trigger signal.

The electronic device further includes a counter. The counter is electrically connected to the time digital converter. The counter receives the first indication signal, the second indication signal, and the trigger signal. The counter counts the first indication signal to obtain a first lap number. The counter counts the second indication signal to obtain a second lap number. The counter resets the first lap number and the second lap number according to the trigger signal.

The electronic device further includes a buffer. The buffer is electrically connected to the counter and the time digital converter. The buffer receives the first lap number and the second lap number from the counter, and receives the trigger signal from the time digital converter. The buffer stores the first lap number and the second lap number from the counter, and outputs the first lap number and the second lap number according to the trigger signal.

The electronic device further includes a comparator. The comparator is electrically connected the counter and the buffer. The comparator receives the first lap number and the second lap number from the counter, and calculates the sum of the first time difference and the second time difference according to the first lap number and the second lap number to obtain a first sum. When the buffer receives the trigger signal, the comparator receives the first lap number and the second lap number of previous period stored in the buffer, and calculates the sum of the first time difference and the second time difference according to the first lap number and the second lap number of previous period to obtain a second sum. The comparator compares the first sum and the second sum, and outputs a comparison result to the clock adjustment circuit.

According to the electronic device described above, the clock adjustment circuit reduces or increases the frequency of the clock signal according to the comparison result from the comparator.

The electronic device further includes a memory. The memory is electrically connected to the counter. The memory receives the first lap number and the second lap number from the counter, and receives the trigger signal from the time digital converter. The memory stores the first lap number and the second lap number from the counter, and outputs the first lap number and the second lap number according to the trigger signal.

The electronic device further includes a machine learning module. The machine learning module receives the first lap number and the second lap number from the counter, calculates the sum of the first time difference and the second time difference according to the first lap number and the second lap number to obtain a first sum. When the buffer receives the trigger signal, the comparator receives the first lap number and the second lap number of previous period stored in the buffer, and calculates the sum of the first time difference and the second time difference according to the first lap number and the second lap number of previous period to obtain a second sum.

According to the electronic device described above, the machine learning module compares the first sum and the second sum to obtain a comparison result, and obtains a drift trend of the frequency of the clock signal according to the comparison result. The machine learning module outputs a control instruction to the clock adjustment circuit according to the drift trend.

According to the electronic device described above, the clock adjustment circuit reduces or increases the frequency of the clock signal according to the control instruction from the machine learning module.

The electronic device further includes a temperature sensor and a voltage detection circuit. The temperature sensor detects the ambient temperature of the electronic device and output temperature data. The voltage detection circuit detects an input voltage in the electronic device and output voltage data. The machine learning module obtains the drift trend of the frequency of the clock signal according to the temperature data, the voltage data, and the comparison result.

The electronic device further includes an event detector. The event detector is electrically connected to the logic controller. The event detector outputs an enable signal to the logic controller according to an event. The logic controller outputs the first signal and the second signal according to the enable signal.

According to the electronic device described above, the event includes expiration of a detection period of a software timer and expiration of a detection period of a real-time clock (RTC).

### BRIEF DESCRIPTION OF THE DRAWINGS

The present invention can be more fully understood by reading the subsequent detailed description and examples with references made to the accompanying drawings.

FIG. 1 is a schematic diagram of an electronic device 100 in accordance with some embodiments of the present invention.

FIG. 2 is a timing diagram of a clock signal 120, a first signal 122, and a second signal 124 in the electronic device 100 of FIG. 1 in accordance with some embodiments of the present invention.

FIG. 3 is a detail schematic diagram of a time digital converter 104 in the electronic device 100 of FIG. 1 in accordance with some embodiments of the present invention.

FIG. 4 is a timing diagram of the clock signal 120, the enable signal 140, the first signal 122, the second signal 124, and a trigger signal 130 in the electronic device 100 of FIG. 1 in accordance with some embodiments of the present invention.

FIG. 5 is a schematic diagram of an electronic device 500 in accordance with some embodiments of the present invention.

FIG. 6 is a schematic diagram of an electronic device 600 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

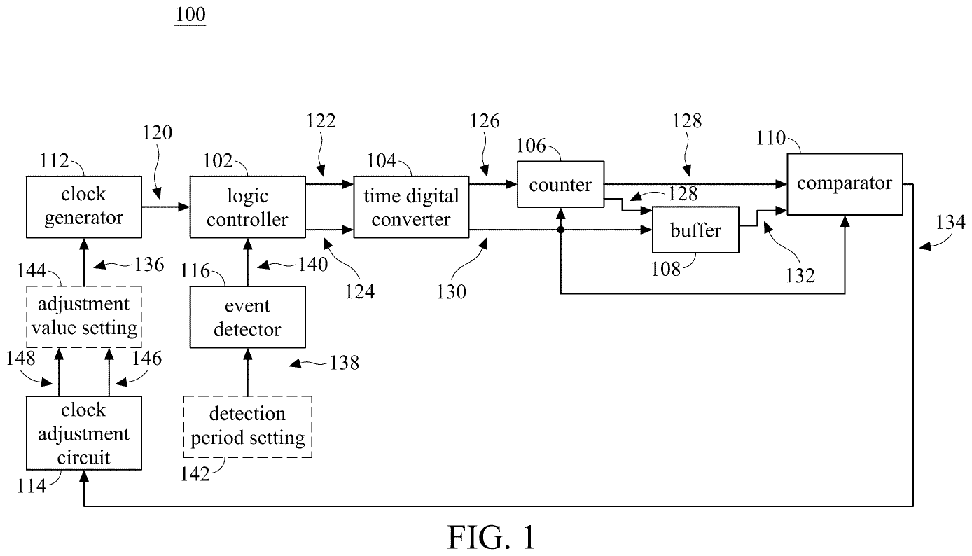

FIG. 1 is a schematic diagram of an electronic device 100 in accordance with some embodiments of the present invention. As shown in FIG. 1, the electronic device 100 includes a logic controller 102, a time digital converter 104, a counter 106, a buffer 108, a comparator 110, a clock generator 112, a clock adjustment circuit 114, and an event detector 116. In some embodiments, the logic controller 102 is electrically connected between the clock generator 112 and the time digital converter 104. The logic controller 102 receives a clock signal 120 from the clock generator 112 and generates a first signal 122 and a second signal 124 according to the clock signal 120. The first signal 122 leads the second signal 124 by a first time difference. In detail, in some embodiments, the rising edge of the first signal 122 is aligned with the rising edge of the clock signal 120, and the rising edge of the second signal 124 is aligned with the falling edge of the clock signal 120, but the present invention is not limited thereto.

The time digital converter 104 is electrically connected between the logic controller 102 and the counter 106, and is also electrically connected between the logic controller 102 and the buffer 108. In some embodiments, the time digital converter 104 includes a plurality of delay circuits. The time digital converter 104 receives the first signal 122 and the second signal 124. The time digital converter 104 enables the second signal 124 to catch up with the first signal 122 in a second time difference through the delay circuits. When the second signal 124 catches up with the first signal 122, the time digital converter 104 outputs a trigger signal 130 accordingly. When the first signal 122 and the second signal 124 travel one lap in the delay circuits, the time digital converter 104 outputs an indication signal 126 accordingly. In some embodiments, the indication signal 126 includes a first indication signal for indicating that the first signal 122 has traveled one lap, and a second indication signal for indicating that the second signal 124 has travel one lap. In some embodiments, the time digital converter 104 may be, for example, a Vernier Ring time digital converter, but the present invention is not limited thereto.

The clock adjustment circuit 114 adjusts the frequency of the clock signal 120 according to the sum of the first time difference and the second time difference calculated in the previous and subsequent periods of the clock signal 120. In detail, the counter 106 receives a first indication signal indicating that the first signal 122 has traveled one lap, a second indication signal indicating that the second signal 124 has traveled one lap, and a trigger signal 130. In some embodiments, the counter 106 counts the first indication signal to obtain a first lap number. The counter 106 counts the second indication signal to obtain a second lap number. In some embodiments, the counter 106 outputs a lap number signal 128 with information of the first lap number and the second lap number in the current period of the clock signal 120 to the comparator 110 and the buffer 108. The counter 106 resets the first lap number and the second lap number according to the trigger signal 130.

The buffer 108 is electrically connected to the counter 106, receives the first lap number and the second lap number from the counter 106, and receives the trigger signal 130 from the time digital converter 104. The buffer 108 stores the first and second lap numbers of the current period of the clock signal 120 from the counter 106 and outputs the first and second lap numbers to the comparator 110 according to the trigger signal 130. For example, in the subsequent period of the clock signal 120, the counter 106 outputs the lap number signal 128 with information of the first lap number and the second lap number in the subsequent period of the clock signal 120 to the comparator 110 and the buffer 108. In the subsequent period of the clock signal 120, when the buffer 108 receives the trigger signal 130, the buffer 108 outputs the lap number signal 132 with the information of the first lap number and the second lap number in the current period of the clock signal 120 stored therein to the comparator 110.

The comparator 110 is electrically connected to the counter 106 and the buffer 108. The comparator 110 receives the first lap number and the second lap number in the lap number signal 128 from the counter 106. The comparator 110 calculates the sum of the first time difference and the second time difference according to the first and second lap numbers in the lap number signal 128 to obtain a first sum. When the buffer 108 receives the trigger signal 130, the comparator 110 receives the first lap number and the second lap number of previous period stored in the buffer 108, and calculates the sum of the first time difference and the second time difference according to the first lap number and the second lap number of previous period to obtain a second sum. The comparator 110 compares the first sum and the second sum, and outputs a comparison result 134 to the clock adjustment circuit 114. The clock adjustment circuit 114 adjusts the frequency of the clock signal 120 according to the comparison result 134. For example, the clock adjustment circuit 114 outputs a control signal 146 to reduce the frequency of the clock signal 120 in the adjustment value setting 144, so that the clock generator 112 changes the frequency of the clock signal 120 according to the control signal 136 from the clock adjustment circuit 114. Similarly, the clock adjustment circuit 114 outputs a control signal 148 to increase the frequency of the clock signal 120 in the adjustment value setting 144.

The event detector 116 is electrically connected to the logic controller 102 and outputs an enabling signal 140 to the logic controller 102 according to an event. The logic controller 102 then generates the first signal 122 and the second signal 124 according to the enable signal 140. In some embodiments, the event includes expiration of a detection period of a software timer and expiration of a detection period of a real-time clock (RTC). In other words, the user can set the detection period of the software timer and the detection period of the real-time clock through the user interface that can display the detection period setting 142. For example, when the user operates the detection period setting 142 through the user interface, the user interface may send an event 138 to the event detector 116. Generally speaking, the software timer is used to set short-term detection periods, such as milliseconds, seconds, minutes, hours, etc. The real-time clock is used to set a long-term detection period, such as day, month, year, etc., but the present invention is not limited thereto.

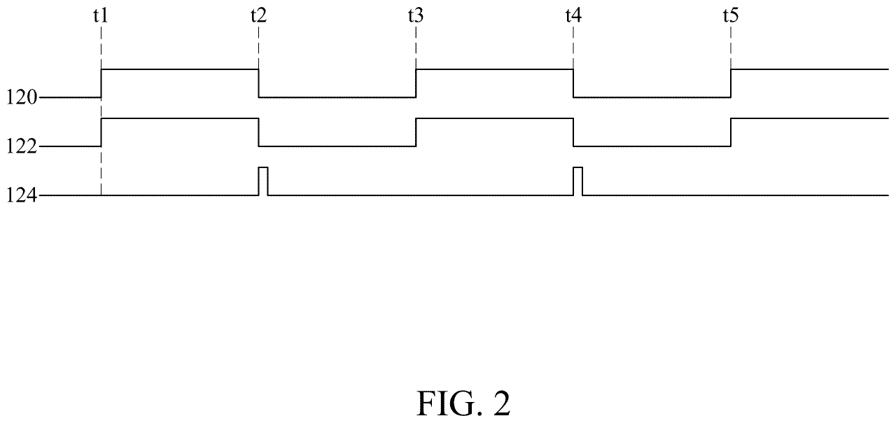

FIG. 2 is a timing diagram of a clock signal 120, a first signal 122, and a second signal 124 in the electronic device 100 of FIG. 1 in accordance with some embodiments of the present invention. As shown in FIG. 2, at time point t1, the logic controller 102 receives the clock signal 120 which changes from a low voltage level to a high voltage level (i.e., the rising edge), and correspondingly outputs the first signal 122 which changes from the low voltage level to the high voltage level (i.e., the rising edge). In other words, in some embodiments of FIG. 2, the first signal 122 is synchronized with the clock signal 120. Then, at time point t2, the clock signal 120 changes from the high voltage level to the low voltage level (i.e., the falling edge), and the logic controller 102 correspondingly outputs the first signal 122 which changes from the high voltage level to the low voltage level (i.e., the falling edge). At the same time, at time point t2, the logic controller 102 outputs the second signal 124 which changes from the low voltage level to the high voltage level.

At time point t3, the clock signal 120 starts the subsequent period. At time point t3, the logic controller 102 outputs the first signal 122 whose voltage level changes from the low level to the high level according to the clock signal 120. At time point t4, the logic controller 102 outputs the first signal 122 that changes from the high voltage level to the low voltage level according to the clock signal 120, and simultaneously outputs the second signal 124 that changes from the low voltage level to the high voltage level. At time point t5, the clock signal 120 starts the subsequent period. Therefore, the logic controller 102 outputs the first signal 122 which changes from the low voltage level to the high voltage level according to the clock signal 120.

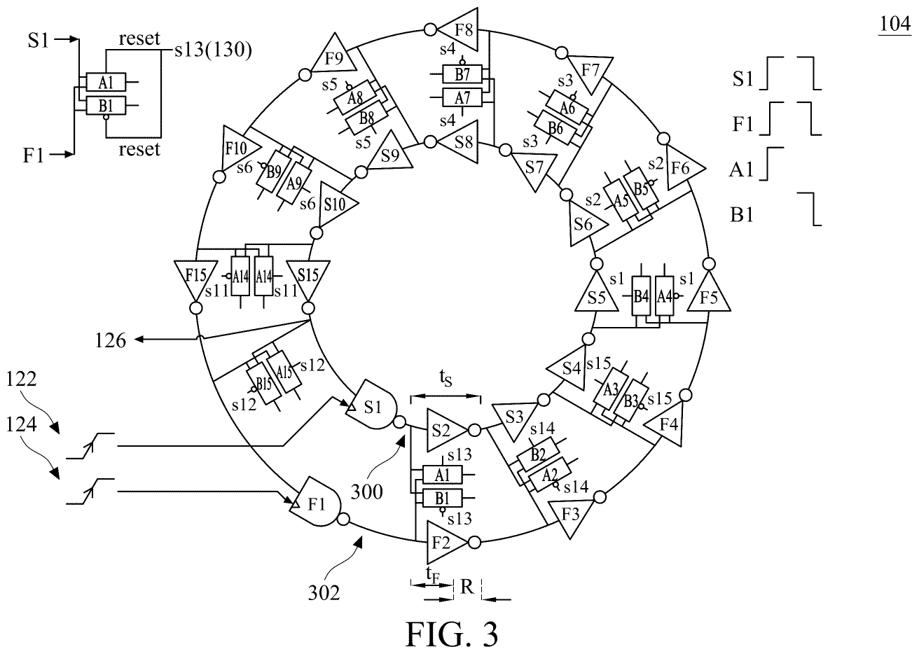

FIG. 3 is a detail schematic diagram of a time digital converter 104 in the electronic device 100 of FIG. 1 in accordance with some embodiments of the present invention. As shown in FIG. 3, the time digital converter 104 includes a first ring delay circuit 300 and a second ring delay circuit 302. The first ring delay circuit 300 receives the first signal 122. When the first signal 122 travels one lap in the first ring delay circuit 300, the first ring delay circuit 300 outputs the indication signal 126 accordingly. The second ring delay circuit 302 receives the second signal 124. When the second signal 124 travels one lap in the second ring delay circuit 302, the second ring delay circuit 302 outputs the indication signal 126 accordingly. The indication signal 126 includes a first indication signal for indicating that the first signal 122 has traveled one lap and a second indication signal for indicating that the second signal 124 has traveled one lap.

In some embodiments of FIG. 3, the first ring delay circuit 300 includes a first NAND gate S1 and a plurality of first inverters (including an inverter S2, an inverter S3, an inverter S4, an inverter S5, an inverter S6, an inverter S7, an inverter S8, an inverter S9, an inverter S10, . . . , and an inverter S15). The first NAND gate S1 includes a first input end, a second input end, and an output end. The second input end receives the first signal 122. The inverters S2 to S15 are connected in series. The inverter S2 is electrically connected to the output end of the first NAND gate S1, and the inverter S15 is electrically connected to the first input end of the first NAND gate S1. The inverter S15 outputs a first indication signal indicating that the first signal 122 has traveled one lap. In some embodiments of FIG. 3, each of the inverters S2 to S15 can delay the first signal 122 by a period tₑₛₜ.

The second ring delay circuit 302 includes a second NAND gate F1 and a plurality of second inverters (including an inverter F2, an inverter F3, an inverter F4, an inverter F5, an inverter F6, an inverter F7, an inverter F8, an inverter F9, an inverter F10, . . . , and an inverter F15). The second NAND gate F1 includes a first input end, a second input end, and an output end. The second input end receives the second signal 124. The inverters F2 to F15 are connected in series. The inverter F2 is electrically connected to the output end of the second NAND gate F1, and the inverter F15 is electrically connected to the first input end of the second NAND gate F1. The inverter F15 outputs a second indication signal indicating that the second signal 124 has traveled one lap. In some embodiments, the number of second inverters is equal to the number of first inverters, but the present invention is not limited thereto. In some embodiments of FIG. 3, each of the inverters F2 to F15 can delay the second signal 124 by a period fₜ. In some embodiments, the period tₑₛₜ is longer than the period fₜ, and the period tₑₛₜ is equal to the period fₜ. plus a period R.

For example, since the first signal 122 leads the second signal 124 by the first time difference, the first time difference is equal to the time period tₑₛₜ multiplied by the first lap number that the first signal 122 has traveled in the first ring delay circuit 300 before the second signal 124 is input. Since the second signal 124 needs the second time difference to catch up with the first signal 122, the second time difference is equal to the time period f_{t.} multiplied by the second lap number that the second signal 124 has traveled in the second ring delay circuit 302 when the second signal 124 catches up with the first signal 122.

The time digital converter 104 further includes a plurality of trigger circuits, including trigger circuits A1 and B1, trigger circuits A2 and B2, trigger circuits A3 and B3, trigger circuits A4 and B4, trigger circuits A5 and B5, trigger circuits A6 and B6, trigger circuits A7 and B7, trigger circuits A8 and B8, trigger circuits A9 and B9, . . . , trigger circuits A14 and B14, and trigger circuits A15 and B15. In some embodiments of FIG. 3, the trigger circuits A1 and B1 are connected between the output end of the first NAND gate S1 and the output end of the second NAND gate F1. The trigger circuits A2 and B2 are connected between the output end of inverter S2 and the output end of inverter F2. The trigger circuits A3 and B3 are connected between the output end of inverter S3 and the output end of inverter F3. The trigger circuits A4 and B4 are connected between the output end of inverter S4 and the output end of inverter F4.

The trigger circuits A5 and B5 are connected between the output end of inverter S5 and the output end of inverter F5. The trigger circuits A6 and B6 are connected between the output end of inverter S6 and the output end of inverter F6. The trigger circuits A7 and B7 are connected between the output end of inverter S7 and the output end of inverter F7. The trigger circuits A8 and B8 are connected between the output end of inverter S8 and the output end of inverter F8. The trigger circuits A9 and B9 are connected between the output end of inverter S9 and the output end of inverter F9. The trigger circuits A14 and B14 are connected between the output end of inverter S14 and the output end of inverter F14. The trigger circuits A15 and B15 are connected between the output end of inverter S15 and the output end of inverter F15. Similarly, the electrical connections of the remaining trigger circuits are analogous to the above description.

In some embodiments of FIG. 3, the trigger circuits A1 to A15 detects whether the rising edge of the first signal 122 running in the first ring delay circuit 300 is aligned with the rising edge of the second signal 124 running in the second ring delay circuit 302. The trigger circuits B1 to B15 detects whether the falling edge of the first signal 122 running in the first ring delay circuit 300 is aligned with the falling edge of the second signal 124 running in the second ring delay circuit 302. For example, when the trigger circuit A1 detects that the rising edge of the first signal 122 is aligned with the rising edge of the second signal 124, the trigger circuit A1 outputs a trigger signal s13 (i.e., the trigger signal 130 in FIG. 1). When the trigger circuit B1 detects that the falling edge of the first signal 122 is aligned with the falling edge of the second signal 124, the trigger circuit B1 also outputs the trigger signal s13 (i.e., the trigger signal 130 in FIG. 1). The trigger signal s13 can also be used to reset the counter 106. When the trigger circuit A2 detects that the rising edge of the first signal 122 is aligned with the rising edge of the second signal 124, the trigger circuit A2 outputs the trigger signal s14 (i.e., the trigger signal 130 in FIG. 1). When the trigger circuit B2 detects that the falling edge of the first signal 122 is aligned with the falling edge of the second signal 124, the trigger circuit B2 also outputs the trigger signal s14 (i.e., the trigger signal 130 in FIG. 1).

When the trigger circuit A3 detects that the rising edge of the first signal 122 is aligned with the rising edge of the second signal 124, the trigger circuit A3 outputs the trigger signal s15 (i.e., the trigger signal 130 in FIG. 1). When the trigger circuit B3 detects that the falling edge of the first signal 122 is aligned with the falling edge of the second signal 124, the trigger circuit B3 also outputs the trigger signal s15 (i.e., the trigger signal 130 in FIG. 1). When the trigger circuit A4 detects that the rising edge of the first signal 122 is aligned with the rising edge of the second signal 124, the trigger circuit A4 outputs the trigger signal s1 (i.e., the trigger signal 130 in FIG. 1). When the trigger circuit B4 detects that the falling edge of the first signal 122 is aligned with the falling edge of the second signal 124, the trigger circuit B4 also outputs the trigger signal s1 (i.e., the trigger signal 130 in FIG. 1). The operations of trigger circuits A5 and B5, trigger circuits A6 and B6, trigger circuits A7 and B7, trigger circuits A8 and B8, trigger circuits A9 and B9, trigger circuits A10 and B10, . . . , trigger circuits A14 and B14, and trigger circuits A15 and B15 are the same as those of trigger circuits A1 and B1, so they will not be repeated herein.

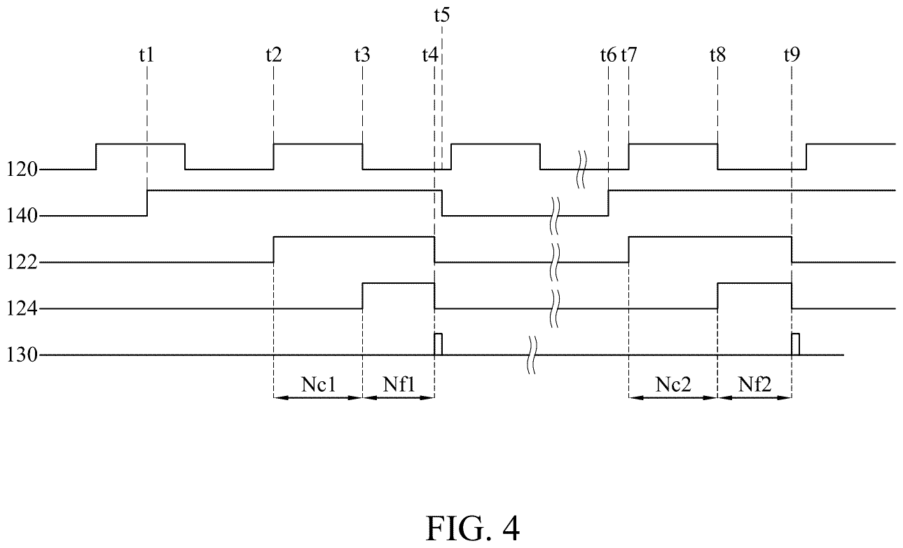

FIG. 4 is a timing diagram of the clock signal 120, the enable signal 140, the first signal 122, the second signal 124, and the trigger signal 130 in the electronic device 100 of FIG. 1 in accordance with some embodiments of the present invention. As shown in FIG. 4, the clock signal 120 is used as a reference for the first signal 122 and the second signal 124. At time point t1, the logic controller 102 receives the enable signal 140 from the event detector 116. Therefore, at time point t2, the logic controller 102 generates the first signal 122 which changes from the low voltage level to the high voltage level (i.e., the rising edge). At time point t3, the logic controller 102 generates the second signal 124 which changes from the low voltage level to the high voltage level (i.e., the rising edge). The first time difference between the first signal 122 and the second signal 124 is equal to the time period Nc1.

Through the first and second ring delay circuits 300 and 302 in the time digital converter 104, the second signal 124 takes the second time difference to catch up with the first signal 122 at time point t4. The second time difference is equal to the time period Nf1. Since the second signal 124 catches up with the first signal 122 at time point t4, that is, the falling edge of the second signal 124 is aligned with the falling edge of the first signal 122, the time digital converter 104 outputs the trigger signal 130. The trigger signal 130 is at the high voltage level between time point t4 and time point t5. In the successive periods of the clock signal 120, at time point t6, the logic controller 102 receives the enable signal 140 from the event detector 116. Therefore, at time point t7, the logic controller 102 generates the first signal 122 which changes from the low voltage level to the high voltage level (i.e., the rising edge). At time point t8, the logic controller 102 generates the second signal 124 which changes from the low voltage level to the high voltage level (i.e., the rising edge). The first time difference between the first signal 122 and the second signal 124 is equal to the period Nc2.

Through the first ring delay circuit 300 and the second ring delay circuit 302 in the time digital converter 104, the second signal 124 takes the second time difference to catch up with the first signal 122 at time point t9. The second time difference is equal to the time period Nf2. Since the second signal 124 catches up with the first signal 122 at time point t9, that is, the falling edge of the second signal 124 is aligned with the falling edge of the first signal 122, the time digital converter 104 outputs the trigger signal 130, so that the trigger signal 130 changes from the low voltage level to the high voltage level at time point t9.

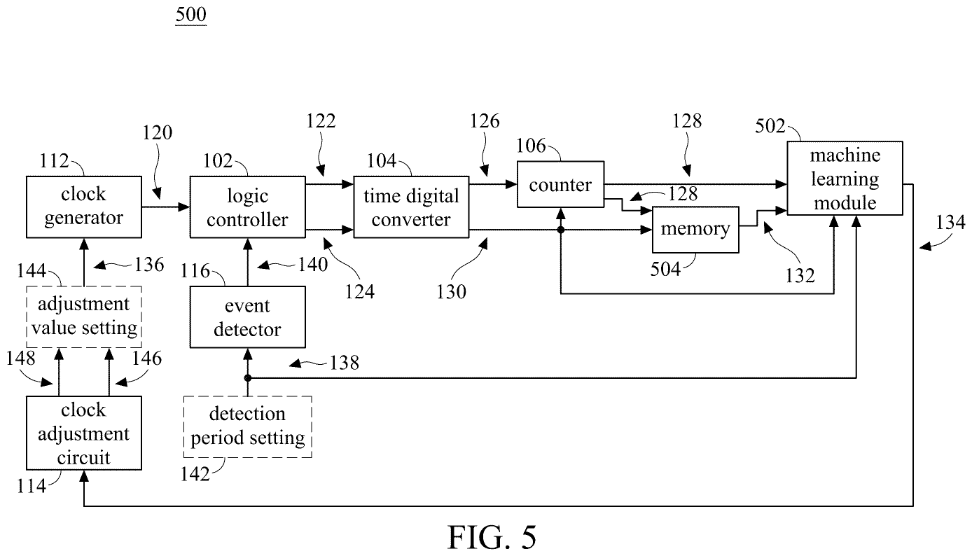

FIG. 5 is a schematic diagram of an electronic device 500 in accordance with some embodiments of the present invention. The biggest difference between FIG. 5 and FIG. 1 is that in FIG. 5, the electronic device 500 replaces the comparator 110 in the electronic device 100 with a machine learning module 502, and the electronic device 500 replaces the buffer 108 in the electronic device 100 with a memory 504. The memory 504 is electrically connected to the counter 106, receives the first lap number and the second lap number from the counter 106, and receives the trigger signal 130 from the time digital converter 104. The memory 504 stores the first lap number and the second lap number from the counter 106 and outputs the first lap number and the second lap number according to the trigger signal 130. The machine learning module 502 receives the first lap number and the second lap number from the counter 106 through the lap number signal 128. The machine learning module 502 calculates the sum of the first time difference and the second time difference according to the first lap number and the second lap number to obtain a first sum.

when the memory 504 receives the trigger signal 130 from the time digital converter 104, the machine learning module 502 receives the first lap number and the second lap number of previous period stored in the memory 504 through the lap number signal 132, and calculates the sum of the first time difference and the second time difference according to the first lap number and the second lap number of previous period to obtain a second sum. The machine learning module 502 compares the first sum and the second sum to obtain a comparison result 134, and obtains a drift trend of the frequency of the clock signal 120 according to the comparison result 134. The machine learning module 502 outputs a control instruction to the clock adjustment circuit 114 according to the drift trend. The clock adjustment circuit 114 reduces or increases the frequency of the clock signal according to the control instruction from the machine learning module 502.

For example, the clock adjustment circuit 114 outputs a control signal 146 to reduce the frequency of the clock signal 120 in the adjustment value setting 144, so that the clock generator 112 changes the frequency of the clock signal 120 according to the control signal 136 from the clock adjustment circuit 114. Similarly, the clock adjustment circuit 114 outputs a control signal 148 to increase the frequency of the clock signal 120 in the adjustment value setting 144. In some embodiments, the machine learning module 502 needs to be trained before it can be applied to the electronic device 500. For example, the present invention inputs the effects of different ambient temperatures or different input voltages on the frequency of the clock signal 120 as training material to the machine learning module 502, so that the machine learning module 502 can accurately obtain the drift trend of the frequency of the clock signal 120.

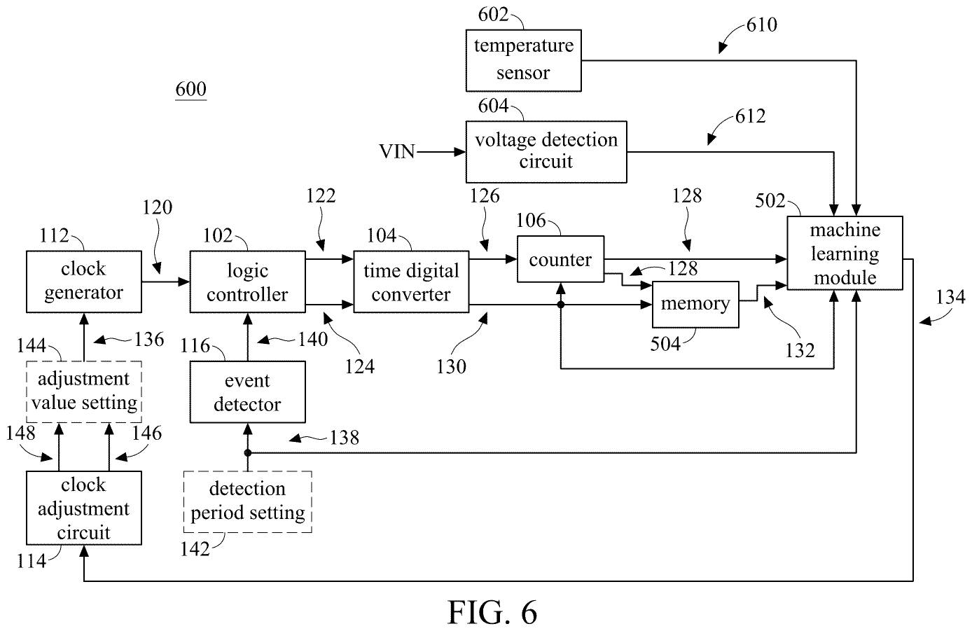

FIG. 6 is a schematic diagram of an electronic device 600 in accordance with some embodiments of the present invention. The biggest difference between FIG. 6 and FIG. 5 is that in FIG. 6, the electronic device 600 further includes a temperature sensor 602 and a voltage detection circuit 604. The temperature sensor 602 detects the ambient temperature of the electronic device 600 and outputs temperature data 610 to the machine learning module 502. The voltage detection circuit 604 detects the input voltage VIN in the electronic device 600 and outputs voltage data 612 to the machine learning module 502. The machine learning module 502 compares the first sum and the second sum to obtain a comparison result 134, and obtains a drift trend of the frequency of the clock signal 120 according to the comparison result 134, the temperature data 610, and the voltage data 612. The machine learning module 502 outputs a control instruction to the clock adjustment circuit 114 according to the drift trend. The clock adjustment circuit 114 reduces or increases the frequency of the clock signal according to the control instruction from the machine learning module 502.

The electronic devices 100, 500, and 600 of the present invention do not require an additional reference clock. Instead, they directly utilize the time digital converter 104 and the counter 106 to accurately detect input clocks of various frequencies (including low-frequency clocks and high-frequency clocks) and detect any component weakening at any time.

With the electronic devices 100, 500, and 600 of the present invention, when the RC crystal oscillator in the chip weakens due to long-term use, an auxiliary circuit for automatic detection can be used as a reference for real data, and the adjustment value can be automatically adjusted according to the change in the counter value of the previous and subsequent periods, so that the chip frequency can be restored to the original chip specification requirements.

The main feature of the time digital converter 104 and the counter 106 is that they can properly integrate the accuracy of time and the logical count value. If the delay circuit is small, it can have a higher time measurement accuracy, but in this case, more counter bits are required to measure a longer time period pulse. Therefore, the delay value of the delay circuit and the number of counter bits can be adaptively adjusted according to the clock frequency to be detected.

The number of inverters included in the first ring delay circuit 300 or the second ring delay circuit 302 is also related to the resolution that can be detected. Therefore, it is also a parameter that can be adjusted in real time according to user needs during design.

The electronic devices 100, 500, and 600 of the present invention utilize a real-time clock (RTC) or a software timer as a reference time for detecting the weakened frequency of the crystal oscillator, thereby reducing the need for frequent detection during each RC frequency cycle and reducing the relative operating power.

The machine learning module 502 can better reflect the crystal oscillator frequency of the system chip under various conditions and reflect that its frequency is a numerical value by receiving the temperature data 610 from the temperature sensor 602 and the output voltage data 612 from the voltage detection circuit 604.

The electronic device 600 of the present invention inputs the first lap number and the second lap number from the counter 106 into the machine learning module 502, and the machine learning module 502 estimates the RC frequency change and performs control to correct the RC frequency.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a logic controller, configured to receive a clock signal, and generate a first signal and a second signal according to the clock signal; wherein the first signal leads the second signal by a first time difference;
a time digital converter, comprising a plurality of delay circuits, configured to receive the first signal and the second signal, and enable the second signal to catch up with the first signal in a second time difference through the delay circuits; and
a clock adjustment circuit, configured to adjust a frequency of the clock signal according to a sum of the first time difference and the second time difference respectively calculated in previous and subsequent periods of the clock signal.

2. The electronic device as claimed in claim 1, wherein the delay circuits comprise:
a first ring delay circuit, configured to receive the first signal; wherein when the first signal travels one lap in the first ring delay circuit, the first ring delay circuit outputs a first indication signal accordingly; and
a second ring delay circuit, configured to receive the second signal; wherein when the second signal travels one lap in the second ring delay circuit, the second ring delay circuit outputs a second indication signal accordingly.

3. The electronic device as claimed in claim 2, wherein the first ring delay circuit comprises:
a first NAND gate, comprising a first input end, a second input end, and an output end; wherein the second input end receives the first signal; and
a plurality of first inverters, all of which are connected in series, wherein the first inverter is electrically connected to the output end of the first NAND gate, and the last inverter is electrically connected to the first input end of the first NAND gate;
wherein the last inverter among the first inverters outputs the first indication signal.

4. The electronic device as claimed in claim 3, wherein the second ring delay circuit comprises:
a second NAND gate, comprising a first input end, a second input end, and an output end; wherein the second input end receives the second signal; and
a plurality of second inverters, each of which is connected in series, wherein the first inverter is electrically connected to the output end of the second NAND gate, and the last inverter is electrically connected to the first input end of the second NAND gate;
wherein the last inverter among the second inverters outputs the second indication signal;
wherein the number of second inverters is equal to the number of first inverters.

5. The electronic device as claimed in claim 4, wherein the time digital converter further comprises:
a plurality of trigger circuits, one of which is connected between the output end of the first NAND gate and the output end of the second NAND gate, and the rest of which are connected between each of the first inverters and each of the second inverters;
wherein when the second signal catches up with the first signal, the one of the trigger circuits outputs a trigger signal.

6. The electronic device as claimed in claim 5, further comprising:
a counter, electrically connected to the time digital converter, configured to receive the first indication signal, the second indication signal, and the trigger signal;
wherein the counter counts the first indication signal to obtain a first lap number; the counter counts the second indication signal to obtain a second lap number;
wherein the counter resets the first lap number and the second lap number according to the trigger signal.

7. The electronic device as claimed in claim 6, further comprising:
a buffer, electrically connected to the counter and the time digital converter, configured to receive the first lap number and the second lap number from the counter, and receive the trigger signal from the time digital converter;
wherein the buffer stores the first lap number and the second lap number from the counter, and outputs the first lap number and the second lap number according to the trigger signal.

8. The electronic device as claimed in claim 7, further comprising:
a comparator, electrically connected the counter and the buffer, configured to receive the first lap number and the second lap number from the counter, and calculate the sum of the first time difference and the second time difference according to the first lap number and the second lap number to obtain a first sum;
wherein when the buffer receives the trigger signal, the comparator receives the first lap number and the second lap number of previous period stored in the buffer, and calculates the sum of the first time difference and the second time difference according to the first lap number and the second lap number of previous period to obtain a second sum;
wherein the comparator compares the first sum and the second sum, and outputs a comparison result to the clock adjustment circuit.

9. The electronic device as claimed in claim 8, wherein the clock adjustment circuit reduces or increases the frequency of the clock signal according to the comparison result from the comparator.

10. The electronic device as claimed in claim 6, further comprising:
a memory, electrically connected to the counter, configured to receive the first lap number and the second lap number from the counter, and receive the trigger signal from the time digital converter;
wherein the memory stores the first lap number and the second lap number from the counter, and outputs the first lap number and the second lap number according to the trigger signal.

11. The electronic device as claimed in claim 10, further comprising:
a machine learning module, configured to receive the first lap number and the second lap number from the counter, and to calculate the sum of the first time difference and the second time difference according to the first lap number and the second lap number to obtain a first sum;
wherein when the memory receives the trigger signal, the machine learning module receives the first lap number and the second lap number of previous period stored in the memory, and calculates the sum of the first time difference and the second time difference according to the first lap number and the second lap number of previous period to obtain a second sum.

12. The electronic device as claimed in claim 11, wherein the machine learning module compares the first sum and the second sum to obtain a comparison result, and obtains a drift trend of the frequency of the clock signal according to the comparison result;
wherein the machine learning module outputs a control instruction to the clock adjustment circuit according to the drift trend.

13. The electronic device as claimed in claim 12, wherein the clock adjustment circuit reduces or increases the frequency of the clock signal according to the control instruction from the machine learning module.

14. The electronic device as claimed in claim 12, further comprising:
a temperature sensor, configured to detect an ambient temperature of the electronic device and output temperature data; and
a voltage detection circuit, configured to detect an input voltage in the electronic device and output voltage data;
wherein the machine learning module obtains the drift trend of the frequency of the clock signal according to the temperature data, the voltage data, and the comparison result.

15. The electronic device as claimed in claim 1, further comprising:
an event detector, electrically connected to the logic controller, configured to output an enable signal to the logic controller according to an event;
wherein the logic controller outputs the first signal and the second signal according to the enable signal.

16. The electronic device as claimed in claim 15, wherein the event comprises expiration of a detection period of a software timer and expiration of a detection period of a real-time clock (RTC).
